(19) United States
(12) Patent Application Publication
(10) Pub. No.: US 2017/0275516 A1
(43) Pub. Date: Sep. 28, 2017

(54) RHEOLOGY MODIFIERS COMPRISING DICARBOXYLIC ACID AND METHODS OF USE THEREOF

(71) Applicant: Secure Energy (Drilling Services) Inc., Calgary (CA)

(72) Inventors: Kuangbiao Ma, Calgary (CA); Javier Borau-Garcia, Calgary (CA); Stuart Dubberley, Calgary (CA)

(21) Appl. No.: 15/465,731

(22) Filed: Mar. 22, 2017

Related U.S. Application Data
(60) Provisional application No. 62/311,664, filed on Mar. 22, 2016.

(51) Int. Cl. C09K 8/035; C09K 8/34

(52) U.S. Cl. CPC C09K 8/035; C09K 8/34

(57) ABSTRACT

Rheology modifiers comprising dicarboxylic acid, additives and oil-based drilling fluids comprising said rheology modifiers, as well as methods and uses thereof are provided. The rheology modifier dicarboxylic acid may comprise, for example, dodecanedioic acid. Rheology modifiers as described herein may be used, for example, to increase low shear end viscosity of an oil-based drilling fluid.

### RELATED APPLICATION

This application claims the benefit of priority from U.S. Patent Application No. 62/311,664 filed Mar. 22, 2016, the entire contents of which is herein incorporated by reference.

### FIELD OF INVENTION

The present invention relates generally to drilling operations and fluids therefor. More specifically, the present invention relates to rheology modifiers for such fluids, as well as methods and uses thereof.

### BACKGROUND

Natural resource exploration and recovery often requires the drilling of subterranean formations. Drills are used to bore holes into the earth, creating wellbores for exploring, accessing, and/or recovering natural resources in subterranean formations. Drilling operations often employ drilling fluids, also referred to as drilling muds, to facilitate drilling by cooling the drill bit, and by carrying drill cuttings out of the wellbore during circulation of the drilling fluid in the wellbore.

Drilling fluids may be aqueous or oil-based. Oil-based muds or drilling fluids comprise oil as the continuous phase, and may optionally further comprise various amounts of water or brine as a dispersed phase. Depending on the water content, oil-based drilling fluids can be divided into invert emulsion-based, or all-oil based, systems. Invert emulsion-based drilling fluids may comprise, for example, up to about 95:5 ratio by volume oil phase to water phase, and may use emulsifiers to stabilize water-in-oil emulsion. All-oil based systems are those in which the drilling fluid comprises oil but does not include a water or brine phase.

Flow properties of a drilling fluid impact both the hole cleaning and suspension ability of the drilling fluid. Conventionally, organophilic clays have been used as rheological additives in oil based invert, all-oil, or synthetic-based drilling fluids in an effort to provide a desired viscosity.

Commercially available rheology modifiers used as drilling fluid additives include dimer and trimer fatty acids, imidazolines, amides, and synthetic polymers. “Dimer acids” are dimerized unsaturated fatty acids obtained from tall oil. These “dimer acids” are predominantly dimers of stearic acid (C₁₈) having a variety of different possible C₃₆ structures including non-linear/branched alkyl chains and/or rings which may or may not be aromatic.

An alternative, additional, and/or improved rheology modifier is desirable.

### SUMMARY OF INVENTION

In an embodiment, there is provided herein a use of a dicarboxylic acid compound of formula I:

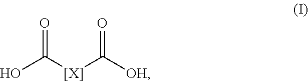

where X is a suitable alkyl or modified alkyl group,
as a rheology modifier in an oil-based drilling fluid.

In certain embodiments, X may be any suitable alkyl or modified alkyl. For example, suitable alkyls may include linear or branched and optionally substituted alkyl groups. Modified alkyl groups may include linear or branched, saturated or unsaturated, optionally substituted alkyl, alkenyl or alkynyl groups. In a further embodiment, X may be a suitable C₈-C₁₂ linear or branched, saturated or unsaturated, optionally substituted alkyl or modified alkyl group. In still a further embodiment, X may be a linear saturated C₈-C₁₂ alkyl group.

In an embodiment of a use as described above, the dicarboxylic acid compound may be decanedioic acid (i.e. sebacic acid), undecanedioic acid, dodecanedioic acid, tridecanedioic acid, or tetradecanedioic acid, or any combination thereof.

In another embodiment of a use a described above, the dicarboxylic acid compound may be dodecanedioic acid:

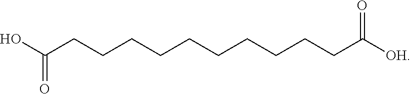 [SMILES: O=C(O)CCCCCCCCCCC(=O)O]

As will be understood by the person of skill in the art, the structure of a dicarboxylic acid compound of formula I is shown in FIG. 1, where X may be any suitable linear or branched, saturated or unsaturated, optionally substituted alkyl group. By way of illustrative example, a suitable X alkyl group may be a linear saturated C₁₀ alkyl group, thus resulting in dodecanedioic acid (C₁₂) as shown in FIG. 2.

In still another embodiment of the use or uses as described above, the oil-based drilling fluid may be an all-oil-based drilling fluid, or an invert emulsion-based drilling fluid. Such an oil-based drilling fluid may comprise, for example, diesel, distillate, synthetic, or mineral oil as base oil or continuous phase. In certain embodiments, the oil-based drilling fluid may comprise synthetic or mineral oil as base oil or continuous phase.

In yet another embodiment of the use or uses described above, the oil-based drilling fluid may further comprise one or more of water, brine, an emulsifier, a viscosifier, a weighting agent, a fluid loss control additive, a further rheology modifier, or an alkalinity regulator.

In another embodiment of the use or uses described above, the rheology modifier may be for increasing viscosity of the oil-based drilling fluid. In certain embodiments, the rheology modifier may be for increasing low shear end viscosity of the oil-based drilling fluid. In certain other embodiments, the rheology modifier may be for selectively increasing low shear end viscosity over high shear viscosity of the oil-based drilling fluid.

In yet another embodiment of the use or uses described above, the oil-based drilling fluid may comprise an oil:water or oil:brine ratio which is from about 100:0 to about 50:50 by volume.

In yet another embodiment of the use or uses described above, the dicarboxylic acid compound may be used at a concentration of up to about 100 kg/m³ in the oil-based drilling fluid.

In another embodiment, there is provided herein a rheology modifier additive for an oil-based drilling fluid, the rheology modifier additive comprising:
a dicarboxylic acid compound of formula I:

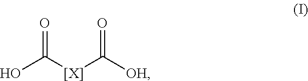

where X is a suitable alkyl or modified alkyl group.

In certain embodiments, X may be any suitable linear or branched, saturated or unsaturated, optionally substituted alkyl group. In a further embodiment, X may be a suitable C₈-C₁₂ linear or branched, saturated or unsaturated, optionally substituted alkyl group. In still a further embodiment, X may be a linear saturated C₈-C₁₂ alkyl group.

In an embodiment of the rheology modifier additive or additives described above, the dicarboxylic acid compound of formula I may be decanedioic acid (i.e. sebacic acid), undecanedioic acid, dodecanedioic acid, tridecanedioic acid, or tetradecanedioic acid, or any combination thereof.

In yet another embodiment of the rheology modifier additive or additives described above, the dicarboxylic acid compound of formula I may be dodecanedioic acid:

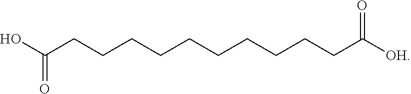 [SMILES: O=C(O)CCCCCCCCCCC(=O)O]

In yet another embodiment of the rheology modifier additive or additives described above, the rheology modifier additive may further comprise diesel, distillate, synthetic, or mineral oil.

In still another embodiment of the rheology modifier additive or additives described above, the rheology modifier may further comprise one or more of water, brine, an emulsifier, a viscosifier, a weighting agent, a fluid loss control additive, a further rheology modifier, or an alkalinity regulator.

In another embodiment of the rheology modifier additive or additives described above, the rheology modifier additive may be for increasing viscosity of the oil-based drilling fluid.

In yet another embodiment of the rheology modifier additive or additives described above, the rheology modifier additive may be for increasing low shear end viscosity of the oil-based drilling fluid.

In still another embodiment, the rheology modifier additive or additives described above may be for selectively increasing low shear end viscosity over high shear viscosity of the oil-based drilling fluid.

In still another embodiment, there is provided herein an oil-based drilling fluid comprising:
a dicarboxylic acid rheology modifier of formula I:

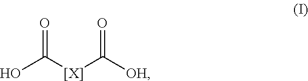

where X is a suitable alkyl or modified alkyl group, and
an oil base or continuous phase.

In certain embodiments, X may be any suitable linear or branched, saturated or unsaturated, optionally substituted alkyl group. In a further embodiment, X may be a suitable C₈-C₁₂ linear or branched, saturated or unsaturated, optionally substituted alkyl group. In still a further embodiment, X may be a linear saturated C₈-C₁₂ alkyl group.

In an embodiment of the oil-based drilling fluid or fluids described above, the dicarboxylic acid rheology modifier may be decanedioic acid (i.e. sebacic acid), undecanedioic acid, dodecanedioic acid, tridecanedioic acid, or tetradecanedioic acid, or any combination thereof.

In another embodiment of the oil-based drilling fluid or fluids described above, the dicarboxylic acid rheology modifier may be dodecanedioic acid:

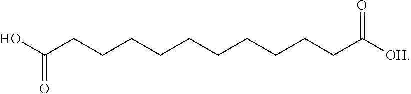 [SMILES: O=C(O)CCCCCCCCCCC(=O)O]

In still another embodiment of the oil-based drilling fluid or fluids described above, the oil-based drilling fluid may be an all-oil-based drilling fluid, or an invert emulsion-based drilling fluid.

In another embodiment of the oil-based drilling fluid or fluids described above, the oil base or continuous phase may comprise diesel, distillate, synthetic, or mineral oil. In certain embodiments, the oil base or continuous phase may comprise synthetic or mineral oil.

In still another embodiment of the oil-based drilling fluid or fluids described above, the oil-based drilling fluid may further comprise one or more of water, brine, an emulsifier, a viscosifier, a weighting agent, a fluid loss control additive, a further rheology modifier, or an alkalinity regulator.

In yet another embodiment of the oil-based drilling fluid or fluids described above, the dicarboxylic acid rheology modifier may be for increasing viscosity of the oil-based drilling fluid. In yet another embodiment, the dicarboxylic acid rheology modifier may be for increasing low shear end viscosity of the oil-based drilling fluid. In still another embodiment, the dicarboxylic acid rheology modifier may be for selectively increasing low shear end viscosity over high shear viscosity of the oil-based drilling fluid.

In another embodiment of the oil-based drilling fluid or fluids described above, the oil-based drilling fluid may comprise an oil:water or oil:brine ratio which is from about 100:0 to about 50:50 by volume.

In yet another embodiment of the oil-based drilling fluid or fluids described above, the dicarboxylic acid rheology modifier may be at a concentration of up to about 100 kg/m³ in the oil-based drilling fluid.

In still another embodiment, there is provided herein a method for drilling a subterranean formation, the method comprising:
drilling into the subterranean formation using a drill, thereby forming a wellbore; and
circulating any of the oil-based drilling fluid or fluids as described above in the wellbore simultaneously or sequentially with drilling.

In still another embodiment, there is provided herein a method for drilling a subterranean formation, the method comprising:
drilling into the subterranean formation using a drill, thereby forming a wellbore; and
circulating an oil-based drilling fluid, mixed with any of the rheology modifier additive or additives as described above, in the wellbore simultaneously or sequentially with drilling.

In another embodiment of a method as described above, the oil-based drilling fluid may be an all-oil-based drilling fluid, or an invert emulsion-based drilling fluid. In still another embodiment, the oil-based drilling fluid may comprise diesel, distillate, synthetic, or mineral oil as base oil or continuous phase. In certain embodiments, the oil-based drilling fluid may comprise synthetic or mineral oil as base oil or continuous phase.

In yet another embodiment of the method or methods as described above, the oil-based drilling fluid may further comprise one or more of water, brine, an emulsifier, a viscosifier, a weighting agent, a fluid loss control additive, a further rheology modifier, or an alkalinity regulator.

In still another embodiment of the method or methods as described above, the oil-based drilling fluid may comprise an oil:water or oil:brine ratio which is from about 100:0 to about 50:50 by volume.

In another embodiment of the method or methods as described above, the dicarboxylic acid compound of the rheology modifier additive may be used at a concentration of up to about 100 kg/m³ in the circulating oil-based drilling fluid.

### BRIEF DESCRIPTION OF DRAWINGS

FIG. 1 shows the chemical structure of a dicarboxylic acid compound of formula I, where where X is a suitable alkyl or modified alkyl group; and

FIG. 2 shows the chemical structure of dodecanedioic acid, a dicarboxylic acid compound comprising a linear C₁₂ alkyl chain.

### DETAILED DESCRIPTION

Described herein are rheology modifiers comprising a dicarboxylic acid compound, additives and oil-based drilling fluids comprising said rheology modifiers, as well as methods and uses thereof. It will be appreciated that embodiments and examples provided herein are for illustrative purposes intended for those skilled in the art, and are not intended or meant to be limiting in any way.

As will be understood to the person of skill in the art having regard to the teachings herein, a rheology modifier may be considered herein as a compound, composition, or additive for oil-based drilling fluids which can provide increased viscosity, for example increased viscosity at low shear rates. Such viscosity increases may be desirable when drilling in many different drilling applications, for example but not limited to high-angle and horizontal well drilling operations. Such a viscosity increase may, for example, facilitate cuttings carrying and/or prevent sag or settling of weighting material.

Drilling fluid viscosity can affect drilling fluid characteristics such as solids suspension properties and circulating pressure losses. Drilling fluid viscosity considerations, and the role of low shear end viscosity of drilling fluids, is described in, for example: Mullen et al., American Association of Drilling Engineers, “Coupling of Technology for Concurrent ECD and Barite Sag Management”, AADE-03-NTCE-29, pages 1-8 (herein incorporated by reference in its entirety).

Additional drilling fluid properties of interest may include plastic viscosity (which represents the viscosity of a drilling fluid when extrapolated to an infinite shear rate on the basis of the Bingham plastic model). Without wishing to be bound by theory, a low plastic viscosity generally indicates that drilling can proceed at a fast rate because the drilling fluid exiting at the bit has low viscosity. As well, the yield point, a parameter of the Bingham plastic model (the zero-shear-rate intercept in a Bingham plastic fluid plot), may be used to evaluate the ability of a drilling fluid to lift cuttings out of the annulus. As well, the 10 second and 10 minute gel properties (shear stress measurements at a low shear rate after the drilling fluid has sat for 10 seconds or 10 minutes) may be of interest as an indication of the gel strength of a drilling fluid.

With regard to gel, certain dicarboxylic acids have been previously shown to gel bitumen under certain conditions: Isare et al., Langmuir, 2009, 25(15):8400-8403 and supporting information (herein incorporated by reference in their entirety).

Indeed, flow properties of a drilling fluid play a role in both the hole cleaning and the suspension abilities of the drilling fluid. Conventionally, organophilic clays have been used as rheological additives in oil-based invert and all-oil based drilling fluids to provide desired viscosity. Rheology modifiers have been used as additives, together with organophilic clays, for oil-based muds in an effort to provide better rheology profile than using organophilic clays alone. The combination of organophilic clays and rheology modifiers may provide increased low shear rate viscosity and/or gel strength with minimal or acceptable increase in plastic viscosity.

It has now been found herein that a dicarboxylic acid compound, dodecanedioic acid (DDDA), may be used to provide desired low shear rate viscosity in invert, all-oil, and synthetic drilling fluids as described in further detail below.

In an embodiment, there is provided herein a use of a dicarboxylic acid compound of formula I:

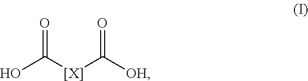

where X is a suitable alkyl or modified alkyl group,
as a rheology modifier in an oil-based drilling fluid.

In certain embodiments, X may be any suitable linear or branched, saturated or unsaturated, optionally substituted alkyl or modified alkyl group. A suitable alkyl group or modified alkyl group may be, for example, an alkyl group which provides increased viscosity and/or increased low shear end viscosity to the oil-based drilling fluid. A suitable alkyl group or modified alkyl may be selected by the person of skill in the art having regard to the teachings herein to suit a particular application such that an appropriate viscosity increase in the oil-based drilling fluid may be obtained. The Examples section below provides examples of how drilling fluid properties such as viscosity, plastic viscosity, yield point, 10 second gel, and 10 minute gel may be determined for a given oil-based drilling fluid following addition of a suitable rheology modifier as described herein thereto.

In certain embodiments, X may be any suitable alkyl or modified alkyl. For example, suitable alkyls may include linear or branched and optionally substituted alkyl groups. Modified alkyl groups may include linear or branched, saturated or unsaturated, optionally substituted alkyl, alkenyl or alkynyl groups. In a further embodiment, X may be a suitable C₈-C₁₂ linear or branched, saturated or unsaturated, optionally substituted alkyl or modified alkyl group. In still a further embodiment, X may be a linear saturated C₈-C₁₂ alkyl group.

In an embodiment of a use as described above, the dicarboxylic acid compound may be decanedioic acid (i.e. sebacic acid), undecanedioic acid, dodecanedioic acid, tridecanedioic acid, or tetradecanedioic acid, or any combination thereof.

In an embodiment of a use as described above, the dicarboxylic acid compound may be, for example, dodecanedioic acid:

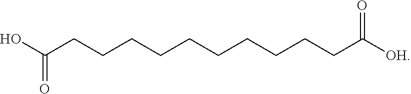 [SMILES: O=C(O)CCCCCCCCCCC(=O)O]

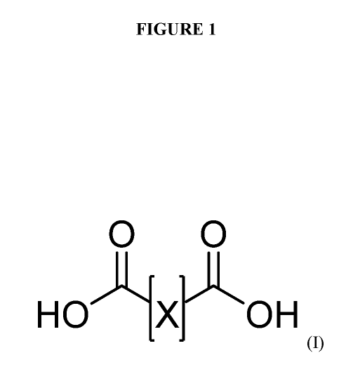

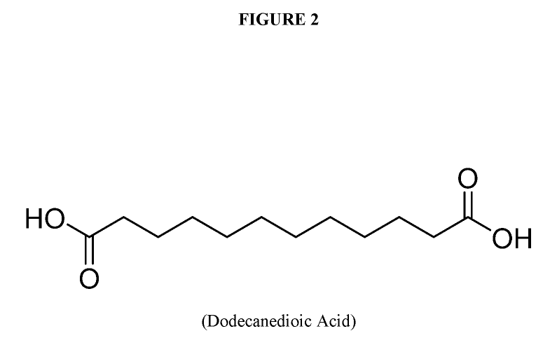

As will be understood by the person of skill in the art having regard to the teachings herein, the structure of a dicarboxylic acid compound of formula I is shown in FIG. 1, where X may be any suitable linear or branched, saturated or unsaturated, optionally substituted alkyl group. By way of illustrative example, a suitable X alkyl group may be a linear saturated C₁₀ alkyl group, thus resulting in dodecanedioic acid (C₁₂) as shown in FIG. 2.

As will also be understood to the person of skill in the art having regard to the teachings herein, the oil-based drilling fluid may be, for example, an all-oil-based drilling fluid, or an invert emulsion-based drilling fluid. Such an oil-based drilling fluid may comprise, for example, diesel, distillate, synthetic, or mineral oil as base oil or continuous phase. As will be understood, oil-based drilling fluids as described herein also include synthetic drilling fluids. A synthetic oil-based drilling fluid may include, for example, linear alphaolefins (LAO) or isomerized olefins (IO), among other suitable options.

In yet another embodiment of any of the use or uses described above, the oil-based drilling fluid may further comprise one or more of water, brine, an emulsifier, a viscosifier, a weighting agent, a fluid loss control additive, a further rheology modifier, and/or an alkalinity regulator. Such components may be selected so as to achieve desired performance properties for a given application.

The person of skill in the art having regard to the teachings herein will be aware of suitable examples of the options described above. An example of an emulsifier includes, for example, Secure Emul™ emulsifier. An example of a further/additional rheology modifier includes, for example, an organophilic clay such as Bentone 150™. An example of a fluid loss control additive includes, for example, Maxtrol™, a natural asphalt. An example of a brine includes, for example, 30% CaCl₂ brine. An example of an alkalinity regulator includes, for example, lime. An example of a distillate includes, for example, Cutter Stock “D”™ distallate. An example of a mineral oil includes, for example, Neodrill™. An example of a weighting agent includes, for example, Barite. An example of a synthetic oil includes, for example, Amodrill 1410™ base oil.

In another embodiment of the use or uses described above, the rheology modifier may be for increasing viscosity of the oil-based drilling fluid. In certain embodiments, the rheology modifier may be for increasing low shear end viscosity of the oil-based drilling fluid. In certain other embodiments, the rheology modifier may be for selectively increasing low shear end viscosity over (i.e. in comparison to) high shear viscosity of the oil-based drilling fluid, wherein the low shear end viscosity of the oil-based drilling fluid is increased by a percentage which is greater than the percentage by which the high shear viscosity of the same oil-based drilling fluid is increased by the rheology modifier.

In yet another embodiment of the use or uses described above, the oil-based drilling fluid may comprise an oil:water or oil:brine ratio which is from about 100:0 to about 50:50 by volume.

In yet another embodiment of the use or uses described above, the dicarboxylic acid compound may be used at a concentration of up to about 100 kg/m³ in the oil-based drilling fluid.

In another embodiment, there is provided herein a rheology modifier additive for an oil-based drilling fluid, the rheology modifier additive comprising:
a dicarboxylic acid compound of formula I:

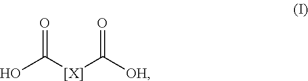

where X is a suitable alkyl or modified alkyl group.

In certain embodiments, X may be any suitable linear or branched, saturated or unsaturated, optionally substituted alkyl group as described herein. In a further embodiment, X may be a suitable C₈-C₁₂ linear or branched, saturated or unsaturated, optionally substituted alkyl group. In still a further embodiment, X may be a linear saturated C₈-C₁₂ alkyl group.

In an embodiment of the rheology modifier additive or additives described above, the dicarboxylic acid compound of formula I may be decanedioic acid (i.e. sebacic acid), undecanedioic acid, dodecanedioic acid, tridecanedioic acid, or tetradecanedioic acid, or any combination thereof.

In yet another embodiment of the rheology modifier additive or additives described above, the dicarboxylic acid compound of formula I may be dodecanedioic acid:

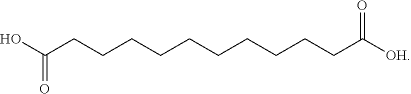 [SMILES: O=C(O)CCCCCCCCCCC(=O)O]

In yet another embodiment of the rheology modifier additive or additives described above, the rheology modifier additive may further comprise diesel, distillate, synthetic, or mineral oil.

In still another embodiment of the rheology modifier additive or additives described above, the rheology modifier may further comprise one or more of water, brine, an emulsifier, a viscosifier, a weighting agent, a fluid loss control additive, a further rheology modifier, or an alkalinity regulator.

In another embodiment of the rheology modifier additive or additives described above, the rheology modifier additive may be for increasing viscosity of the oil-based drilling fluid.

In yet another embodiment of the rheology modifier additive or additives described above, the rheology modifier additive may be for increasing low shear end viscosity of the oil-based drilling fluid. In certain other embodiments, the rheology modifier additive or additives may be for selectively increasing low shear end viscosity over high shear viscosity of the oil-based drilling fluid.

In still another embodiment, there is provided herein an oil-based drilling fluid comprising:
a dicarboxylic acid rheology modifier of formula I:

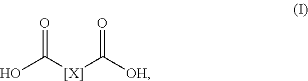

where X is a suitable alkyl or modified alkyl group, and
an oil base or continuous phase.

In certain embodiments, X may be any suitable linear or branched, saturated or unsaturated, optionally substituted alkyl group as described herein. In a further embodiment, X may be a suitable C₈-C₁₂ linear or branched, saturated or unsaturated, optionally substituted alkyl group. In still a further embodiment, X may be a linear saturated C₈-C₁₂ alkyl group.

In an embodiment of the oil-based drilling fluid or fluids described above, the dicarboxylic acid rheology modifier may be decanedioic acid (i.e. sebacic acid), undecanedioic acid, dodecanedioic acid, tridecanedioic acid, or tetradecanedioic acid, or any combination thereof.

In another embodiment of the oil-based drilling fluid or fluids described above, the dicarboxylic acid rheology modifier may be dodecanedioic acid:

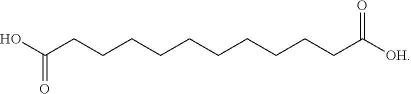 [SMILES: O=C(O)CCCCCCCCCCC(=O)O]

In still another embodiment of the oil-based drilling fluid or fluids described above, the oil-based drilling fluid may be an all-oil-based drilling fluid, or an invert emulsion-based drilling fluid.

In another embodiment of the oil-based drilling fluid or fluids described above, the oil base or continuous phase may comprise diesel, distillate, synthetic, or mineral oil.

In still another embodiment of the oil-based drilling fluid or fluids described above, the oil-based drilling fluid may further comprise one or more of water, brine, an emulsifier, a viscosifier, a weighting agent, a fluid loss control additive, a further rheology modifier, or an alkalinity regulator.

In yet another embodiment of the oil-based drilling fluid or fluids described above, the dicarboxylic acid rheology modifier may be for increasing viscosity of the oil-based drilling fluid. In yet another embodiment, the dicarboxylic acid rheology modifier may be for increasing low shear end viscosity of the oil-based drilling fluid. In certain other embodiments, the dicarboxylic acid rheology modifier may be for selectively increasing low shear end viscosity over high shear viscosity of the oil-based drilling fluid.

In another embodiment of the oil-based drilling fluid or fluids described above, the oil-based drilling fluid may comprise an oil:water or oil:brine ratio which is from about 100:0 to about 50:50 by volume.

In yet another embodiment of the oil-based drilling fluid or fluids described above, the dicarboxylic acid rheology modifier may be at a concentration of up to about 100 kg/m³ in the oil-based drilling fluid.

In still another embodiment, there is provided herein a method for drilling a subterranean formation, the method comprising:
drilling into the subterranean formation using a drill, thereby forming a wellbore; and
circulating any of the oil-based drilling fluid or fluids as described above in the wellbore simultaneously or sequentially with drilling.

In still another embodiment, there is provided herein a method for drilling a subterranean formation, the method comprising:
drilling into the subterranean formation using a drill, thereby forming a wellbore; and
circulating an oil-based drilling fluid, mixed with any of the rheology modifier additive or additives as described above, in the wellbore simultaneously or sequentially with drilling.

The person of skill in the art having regard to the teachings herein will be aware of drilling operations, and suitable drilling and fluid circulation techniques associated therewith.

In will be recognized that mixing of the rheology modifier with the oil-based drilling fluid may be performed in any suitable manner. In certain embodiments, the rheology modifier may be added to the drilling fluid before or during circulation in the wellbore. Rheology modifier may be added over a period of time, or all at once. Rheology modifier may, for example, be added to the wellbore through the same apparatus used to introduce drilling fluid, or a different apparatus.

In another embodiment of a method as described above, the oil-based drilling fluid may be an all-oil-based drilling fluid, or an invert emulsion-based drilling fluid. In still another embodiment, the oil-based drilling fluid may comprise diesel, distillate, synthetic, or mineral oil as base oil or continuous phase.

In yet another embodiment of the method or methods as described above, the oil-based drilling fluid may further comprise one or more of water, brine, an emulsifier, a viscosifier, a weighting agent, a fluid loss control additive, a further rheology modifier, or an alkalinity regulator.

In still another embodiment of the method or methods as described above, the oil-based drilling fluid may comprise an oil:water or oil:brine ratio which is from about 100:0 to about 50:50 by volume.

In another embodiment of the method or methods as described above, the dicarboxylic acid compound of the rheology modifier additive may be used at a concentration of up to about 100 kg/m³ in the circulating oil-based drilling fluid.

It will be understood that rheology modifiers and rheology modifier additives as described herein may be used to adjust properties of an oil-based drilling fluid as needed to suit a particular application, or as drilling operation conditions change.

In an embodiment, there is provided herein a method for adjusting viscosity, low shear end viscosity, plastic viscosity, yield point, 10 second gel, and/or 10 minute gel property(ies) of an oil-based drilling fluid comprising:
monitoring one or more of the viscosity, low shear end viscosity, plastic viscosity, yield point, 10 second gel, and/or 10 minute gel property(ies) of the oil-based drilling fluid; and
adding a rheology modifier or rheology modifier additive as described herein to the oil-based drilling fluid to improve or alter the monitored property(ies) of the oil-based drilling fluid.

The person of skill in the art having regard to the teachings herein will understand that drilling fluids as described herein may used in applications beyond the drilling of wellbores.

The person of skill in the art having regard to the teachings herein will also understand that the dicarboxylic acids described herein may also include salt forms thereof. It will be understood that dicarboxylic acids comprise two carboxylic acid functional groups, either or both of which may be in acid or carboxylate salt form depending on the conditions of the system. Thus, in certain embodiments, at least a portion of a given dicarboxylic acid as described herein may be in the form of a salt. In solution, depending on pH, dicarboxylate salts may be in equilibrium between acid and salt forms. During use, the population of dicarboxylic acid salt and acid forms may change as conditions change. Thus, it will be understood that in certain embodiments dicarboxylic acid compounds of formula I:

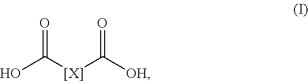

as described herein may also include carboxylate salt(s) thereof. For example, dodecanedioic acid:

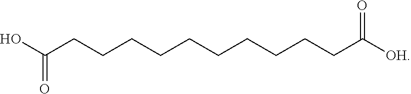 [SMILES: O=C(O)CCCCCCCCCCC(=O)O]

as described herein may, in an embodiment, also include carboxylate salt(s) thereof.

One or more illustrative embodiments have been described by way of example. It will be understood to persons skilled in the art that a number of variations and modifications can be made without departing from the scope of the invention as defined in the claims.

### Example 1: DDDA as Rheology Modifier in 90:10 Invert Using Diesel as Base Oil

Formulations containing DDDA (dodecanedioic acid) as rheology modifier in 90:10 invert using diesel as base oil were tested. The following results, provided in Table 1, were obtained from an OFITE® Model 900 Viscometer. Secure Emul™ is an emulsifier, Bentone 150™ is an organophilic clay, Maxtrol™ is a natural asphalt for fluid loss control, and Rev Dust™ is calcium montmorillonite to simulate drilled solids.

TABLE 1

Drilling Fluid

| | |
|---|---|
| 1 | 2 |

| | |
|---|---|
| Water oil ratio(g) | 90:10 |
| Diesel (g) | 215.87 |
| 30% CaCl₂ brine (mL) | 28.5 |
| Secure Emul ™ (mL) | 2.4 |
| Bentone 150 ™ (g) | 8.4 |
| Lime (g) | 3 |
| Maxtrol ™ (g) | 3 |
| Rev dust ™ (g) | 15 |

| | | |
|---|---|---|
| DDDA (g) | 0 | 1.2 |

| | |
|---|---|
| | OFITE Dial |
| | Reading at |
| Shear Rate (RPM) | 50° C.(Pa) |

| | | |
|---|---|---|
| 600 | 32.9 | 45.2 |
| 300 | 21.1 | 29.9 |
| 200 | 16.7 | 23.7 |
| 100 | 11.8 | 17.0 |
| 6 | 5.1 | 8.2 |
| 3 | 4.7 | 7.1 |

Drilling Fluid Properties

| | | |
|---|---|---|
| Plastic viscosity (mPa · s) | 11.8 | 15.3 |
| Yield point (Pa) | 4.7 | 7.3 |
| 10 second gel (Pa) | 3.4 | 5.3 |
| 10 minute gel (Pa) | 7.2 | 15.0 |

With reference to Table 1, plastic viscosity represents the viscosity of a drilling fluid when extrapolated to an infinite shear rate on the basis of the Bingham plastic model. Without wishing to be bound by theory, a low plastic viscosity generally indicates that drilling can proceed at a fast rate because the drilling fluid exiting at the bit has low viscosity. The yield point is a parameter of the Bingham plastic model (the zero-shear-rate intercept in a Bingham plastic fluid plot), and is used to evaluate the ability of a drilling fluid to lift cuttings out of the annulus. The 10 second and 10 minute gel properties are the shear stress measurements at a low shear rate after the drilling fluid has sat for 10 seconds or 10 minutes. It is an indication of the gel strength of a drilling fluid.

### Example 2: DDDA as Rheology Modifier in 90:10 Invert Using Distillate as Base Oil

Formulations containing DDDA as rheology modifier in 90:10 invert using Cutter Stock “D”™ (distillate) as base oil were tested. The following results, provided in Table 2, were obtained from an OFITE® Model 900 Viscometer.

TABLE 2

Drilling Fluid

| | |
|---|---|
| 1 | 2 |

| | |
|---|---|
| Water oil ratio(g) | 90:10 |
| Cutter Stock “D” ™ (g) | 226.9 |
| 30% CaCl₂ brine (mL) | 28.5 |
| Secure Emul ™ (mL) | 2.4 |
| Bentone 150 ™ (g) | 8.4 |
| Lime (g) | 3 |
| Maxtrol ™ (g) | 3 |
| Rev dust ™ (g) | 15 |

| | | |
|---|---|---|
| DDDA (g) | 0 | 1.2 |

| | |
|---|---|
| | OFITE Dial |
| | Reading at |
| Shear Rate (RPM) | 50° C.(Pa) |

| | | |
|---|---|---|
| 600 | 44.8 | 54.4 |
| 300 | 27.2 | 33.0 |
| 200 | 20.9 | 26.1 |
| 100 | 14.2 | 18.3 |
| 6 | 5.3 | 7.0 |
| 3 | 4.9 | 6.1 |

Drilling Fluid Properties

| | | |
|---|---|---|
| Plastic viscosity (mPa · s) | 17.6 | 21.4 |
| Yield point (Pa) | 4.8 | 5.8 |
| 10 second gel (Pa) | 3.1 | 3.7 |
| 10 minute gel (Pa) | 4.0 | 5.5 |

### Example 3: DDDA as Rheology Modifier in 90:10 Invert Using Mineral Oil as Base Oil

Formulations containing DDDA as rheology modifier in 90:10 invert using Neodrill™ (mineral oil) as base oil were tested. The following results, provided in Table 3, were obtained from an OFITE® Model 900 Viscometer.

TABLE 3

Drilling Fluid

| | |
|---|---|
| 1 | 2 |

| | |
|---|---|
| Water oil ratio(g) | 90:10 |
| Neodrill ™ (g) | 219.4 |
| 30% CaCl₂ brine (mL) | 28.5 |
| Secure Emul ™ (mL) | 2.4 |
| Bentone 150 ™ (g) | 8.4 |
| Lime (g) | 3 |
| Maxtrol ™ (g) | 3 |
| Rev dust ™ (g) | 15 |

| | | |
|---|---|---|
| DDDA (g) | 0 | 1.2 |

| | |
|---|---|
| | OFITE Dial |
| | Reading at |
| Shear Rate (RPM) | 50° C.(Pa) |

| | | |
|---|---|---|
| 600 | 27.8 | 34.5 |
| 300 | 15.3 | 22.9 |
| 200 | 11.1 | 14.2 |
| 100 | 6.0 | 9.0 |
| 6 | 1.9 | 5.3 |
| 3 | 1.4 | 3.9 |

Drilling Fluid Properties

| | | |
|---|---|---|
| Plastic viscosity (mPa · s) | 4.7 | 11.6 |
| Yield point (Pa) | 5.3 | 5.8 |
| 10 second gel (Pa) | 3.1 | 3.3 |
| 10 minute gel (Pa) | 4.0 | 5.9 |

### Example 4: DDDA as Rheology Modifier in 90:10 Invert Using Mineral Oil as Base Oil and Barite as Weighting Material

Formulations containing DDDA as rheology modifier in 90:10 invert using Neodrill™ (mineral oil) as base oil and barite as weighting material were tested. The following results, provided in Table 4, were obtained from an OFITE® Model 900 Viscometer.

TABLE 4

Drilling Fluid

| | |
|---|---|
| 1 | 2 |

| | |
|---|---|
| Water oil ratio(g) | 90:10 |
| Neodrill ™ (g) | 219.4 |
| 30% CaCl₂ brine (mL) | 28.5 |
| Secure Emul ™ (mL) | 2.4 |
| Bentone 150 ™ (g) | 8.4 |
| Lime (g) | 3 |
| Maxtrol ™ (g) | 3 |
| Rev dust ™ (g) | 15 |
| Barite (g) | 60 |

| | | |
|---|---|---|
| DDDA (g) | 0 | 1.2 |

| | |
|---|---|
| | OFITE Dial |
| | Reading at |
| Shear Rate (RPM) | 50° C.(Pa) |

| | | |
|---|---|---|
| 600 | 31.7 | 48.5 |
| 300 | 19.9 | 29.8 |
| 200 | 11.7 | 23.2 |
| 100 | 6.3 | 16.8 |
| 6 | 1.7 | 12.3 |
| 3 | 1.3 | 10.9 |

Drilling Fluid Properties

| | | |
|---|---|---|
| Plastic viscosity (mPa · s) | 11.8 | 18.7 |
| Yield point (Pa) | 4.1 | 5.6 |
| 10 second gel (Pa) | 1.4 | 8.5 |
| 10 minute gel (Pa) | 5.1 | 17.2 |

### Example 5: DDDA as Rheology Modifier in 90:10 Invert Using Synthetic as Base Oil

Formulations containing DDDA as rheology modifier in 90:10 invert using Amodrill 1410™ (synthetic) as base oil were tested. The following results, provided in Table 5, were obtained from an OFITE® Model 900 Viscometer.

TABLE 5

Drilling Fluid

| | |
|---|---|
| 1 | 2 |

| | |
|---|---|
| Water oil ratio(g) | 90:10 |
| Neodrill ™ (g) | 196.6 |
| 30% CaCl₂ brine (mL) | 28.5 |
| Secure Emul ™ (mL) | 2.4 |
| Bentone 150 ™ (g) | 8.4 |
| Lime (g) | 3 |
| Maxtrol ™ (g) | 3 |
| Rev dust ™ (g) | 15 |

| | | |
|---|---|---|
| DDDA (g) | 0 | 1.2 |

| | |
|---|---|
| | OFITE Dial |
| | Reading at |
| Shear Rate (RPM) | 50° C.(Pa) |

| | | |
|---|---|---|
| 600 | 13.1 | 20.6 |
| 300 | 7.1 | 12.9 |
| 200 | 5.0 | 9.8 |
| 100 | 3.1 | 6.6 |
| 6 | 0.6 | 3.8 |
| 3 | 0.4 | 3.4 |

Drilling Fluid Properties

| | | |
|---|---|---|
| Plastic viscosity (mPa · s) | 6.0 | 7.7 |
| Yield point (Pa) | 0.6 | 2.9 |
| 10 second gel (Pa) | 0.5 | 3.9 |
| 10 minute gel (Pa) | 2.7 | 6.7 |

### Example 6: DDDA as Rheology Modifier in Mineral Oil-Based Invert Mud from Field

A sample of mineral oil-based invert mud from field with 89.7:10.3 oil:water ratio was obtained. The mud contained 27 kg/m³ lime, 4.9% of low gravity solids (drilling cuttings), and 16.8% barite with the density 1460 kg/m³. The following results, provided in Table 6, were obtained from an OFITE® Model 900 Viscometer. RM 1 and RM 2 are commercially available rheology modifiers.

TABLE 6

| | Rheology Profile at 50° C. | | | | | | | |
|---|---|---|---|---|---|---|---|---|
| | | | | | | | 10 second | 10 minute |
| Comments | 600 rpm | 300 rpm | 200 rpm | 100 rpm | 6 rpm | 3 rpm | gel (pa) | gel (pa) |
| Field Mud (1) | 49.3 | 29.5 | 20.3 | 11.5 | 2.7 | 2.2 | 1.5 | 4.2 |
| 1 + 2 L/m3 RM 1 | 49.1 | 28.7 | 20.0 | 11.4 | 2.6 | 2.2 | 2.0 | 5.4 |
| 1 + 4 L/m3 RM 1 | 52.8 | 31.2 | 21.3 | 12.2 | 3.6 | 2.7 | 3.1 | 8.0 |
| 1 + 8 L/m3 RM 1 | 54.5 | 32.0 | 22.9 | 13.3 | 4.4 | 3.6 | 5.1 | 13.1 |
| 1 + 2 L/m3 RM 2 | 49.7 | 28.2 | 22.9 | 11.8 | 3.0 | 2.4 | 2.0 | 5.4 |
| 1 + 4 L/m3 RM 2 | 54.4 | 32.9 | 21.7 | 12.5 | 3.8 | 2.9 | 3.1 | 8.0 |
| 1 + 8 L/m3 RM 2 | 56.5 | 33.1 | 24.0 | 14.1 | 4.5 | 3.9 | 5.1 | 13.1 |
| 1 + 2 kg/m3 DDDA | 48.7 | 28.8 | 20.4 | 12.1 | 3.3 | 2.6 | 2.4 | 7.2 |
| 1 + 4 kg/m3 DDDA | 62.3 | 37.8 | 27.3 | 16.5 | 6.5 | 4.9 | 3.7 | 14.3 |
| 1 + 8 kg/m3 DDDA | 72.2 | 48.4 | 38.5 | 26.5 | 14.6 | 13.9 | 7.7 | 22.6 |

As can be seen in the Examples provided above, dodecanedioic acid has been observed to be an excellent rheology modifier in the oil-based drilling fluids tested under the conditions used. In these Examples, DDDA produced the best results in mineral oil and synthetic base oils, and also worked well in diesel and distillate base oils. DDDA compared well with commercially available rheology modifiers identified in Example 6 as RM1 and RM2. The use of DDDA consistently provided higher viscosity to the drilling fluids tested, even under low shear conditions. Low shear rate viscosity (i.e., viscosity under low shear indicated by about 3 or 6 rpm dial readings) may be a particularly relevant property in certain applications, as weighting material sag is believed to happen more often at static/no/low shear conditions and/or when tripping. High shear rate viscosity of drilling fluid, on the other hand, may be of lesser relevance or less desirable in such applications, as high shear rate viscosity may lead to high pump pressure, taking more energy to pump/circulate.

As shown herein, under the conditions tested, DDDA was observed to provide an increase in low shear end viscosity in all examples tested. Particularly marked increases were observed in certain examples. For example, up to an 8.5 fold increase was observed using DDDA in the synthetic base oil of Example 5 (see Table 5; 3 rpm). In each of Examples 1-6, the percentage by which low shear end viscosity (i.e. at 3 and 6 rpm) was increased by DDDA was greater than the percentage by which high shear viscosity at 600 rpm was increased by DDDA in the fluid. These results thus provide examples where DDDA selectively increases low shear end viscosity over high shear rate viscosity of oil-based drilling fluids. In Example 5, for example, low shear end viscosity at 3 rpm was increased by about 8.5 fold by DDDA, whereas high shear viscosity at 600 rpm only increased by about 1.6 fold.

One or more illustrative embodiments have been described by way of example. It will be understood to persons skilled in the art that a number of variations and modifications can be made without departing from the scope of the invention as defined in the claims.

What is claimed is:

1. A rheology modifier additive for an oil-based drilling fluid, the rheology modifier additive comprising:
a dicarboxylic acid compound of formula I: 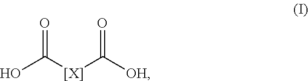
where X is a suitable alkyl or modified alkyl group.

2. The rheology modifier additive according to claim 1, wherein the suitable alkyl or modified alkyl group is C₈-C₁₂.

3. The rheology modifier additive according to claim 1, wherein the dicarboxylic acid compound is dodecanedioic acid:

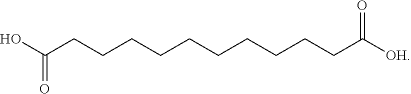 [SMILES: O=C(O)CCCCCCCCCCC(=O)O]

4. The rheology modifier additive according to claim 1, wherein the rheology modifier additive further comprises diesel, distillate, synthetic, or mineral oil.

5. The rheology modifier additive according to claim 1, wherein the rheology modifier further comprises one or more of water, brine, an emulsifier, a viscosifier, a weighting agent, a fluid loss control additive, a further rheology modifier, or an alkalinity regulator.

6. The rheology modifier additive according to claim 1, wherein the rheology modifier additive increases viscosity of the oil-based drilling fluid.

7. The rheology modifier additive according to claim 1, wherein the rheology modifier additive increases low shear end viscosity of the oil-based drilling fluid, or selectively increases low shear end viscosity over high shear viscosity of the oil-based drilling fluid.

8. An oil-based drilling fluid comprising:
a dicarboxylic acid rheology modifier of formula I: 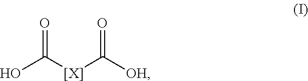
where X is a suitable alkyl or modified alkyl group, and
an oil base or continuous phase.

9. The oil-based drilling fluid according to claim 8, wherein the suitable alkyl or modified alkyl group is C₈-C₁₂.

10. The oil-based drilling fluid according to claim 8, wherein the dicarboxylic acid rheology modifier is dodecanedioic acid:

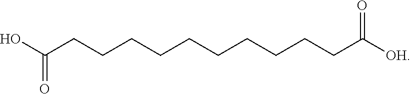 [SMILES: O=C(O)CCCCCCCCCCC(=O)O]

11. The oil-based drilling fluid according to claim 8, wherein the oil-based drilling fluid is an all-oil-based drilling fluid, or an invert emulsion-based drilling fluid.

12. The oil-based drilling fluid according to claim 8, wherein the oil base or continuous phase comprises diesel, distillate, synthetic, or mineral oil.

13. The oil-based drilling fluid according to claim 8, wherein the oil-based drilling fluid further comprises one or more of water, brine, an emulsifier, a viscosifier, a weighting agent, a fluid loss control additive, a further rheology modifier, or an alkalinity regulator.

14. The oil-based drilling fluid according to claim 8, wherein the dicarboxylic acid rheology modifier increases viscosity of the oil-based drilling fluid.

15. The oil-based drilling fluid according to claim 8, wherein the dicarboxylic acid rheology modifier increases low shear end viscosity of the oil-based drilling fluid, or selectively increases low shear end viscosity over high shear viscosity of the oil-based drilling fluid.

16. The oil-based drilling fluid according to claim 8, wherein the oil-based drilling fluid comprises an oil:water or oil:brine ratio which is from about 100:0 to about 50:50 by volume.

17. The oil-based drilling fluid according to claim 8, wherein the dicarboxylic acid rheology modifier is at a concentration of up to about 100 kg/m³.

18. A method for drilling a subterranean formation, the method comprising:
drilling into the subterranean formation using a drill, thereby forming a wellbore; and
circulating an oil-based drilling fluid as defined in claim 8 in the wellbore simultaneously or sequentially with drilling.

19. A method for drilling a subterranean formation, the method comprising:
drilling into the subterranean formation using a drill, thereby forming a wellbore; and
circulating an oil-based drilling fluid, mixed with a rheology modifier additive as defined in claim 1, in the wellbore simultaneously or sequentially with drilling.

20. The method according to claim 19, wherein the dicarboxylic acid compound of the rheology modifier additive is used at a concentration of up to about 100 kg/m³ in the circulating oil-based drilling fluid.
